(19) United States
(12) Patent Application Publication
(10) Pub. No.: US 2015/0232091 A1
(43) Pub. Date: Aug. 20, 2015

(54) METHOD FOR AVOIDING AN ACCIDENT OR FOR REDUCING THE EFFECTS OF AN ACCIDENT FOR A MOTORCYCLE RIDER

(71) Applicants: Thomas Lich, Schwaikheim (DE); Andreas Georgi, Leonberg (DE)

(72) Inventors: Thomas Lich, Schwaikheim (DE); Andreas Georgi, Leonberg (DE)

(21) Appl. No.: 14/374,034

(22) PCT Filed: Jan. 17, 2013
(86) PCT No.: PCT/EP2013/050775

§ 371 Date: Jul. 23, 2014

(30) Foreign Application Priority Data
Mar. 8, 2012 (DE) 10 2012 203 647.4

(51) Int. Cl. B60W 30/09; B60Q 5/00; B60R 21/23; B60Q 1/52; B60T 8/176; B62D 15/02

(52) U.S. Cl. CPC B60W 30/09; B60T 8/176; B62D 15/0265; B60R 21/23; B60Q 1/52; B60Q 5/005

(57) ABSTRACT

A method for avoiding an accident or for reducing the effects of an accident for a rider of a vehicle, especially a two-wheeled or three-wheeled vehicle, includes a first method step in which information is ascertained by a first accident-preventing system and/or a first system for mitigating the effects of an accident; a second method step in which the information is transmitted to a second accident-preventing system and/or a second system for mitigating the effects of an accident; and a third method step in which the second accident-preventing system and/or the second system for mitigating the effects of an accident are/is preconditioned on the basis of the information. The first and second accident-preventing systems differ from each other, and the first and second systems for mitigating the effects of an accident differ from each other.

### BACKGROUND

The number of motor vehicles has increased dramatically over the past few years, with the result that approximately 33 million motorized bikes were registered in Europe in 2008. At the same time, however, it has become apparent that motorcycles are by far the most dangerous means of transportation. Although the share of motorized bikes represents no more than two percent of all road users, their share in the fatality count in Europe amounted to about 14 percent. The motorcycle rider is exposed to a considerably higher risk in road traffic than the driver of an automobile. Among other factors, this is due to the different driving physics and the always unstable balance state, and furthermore the special physical and psychological demands in connection with riding a motorcycle, as well as a restricted viewing field of the driver. At the same time, motorcycle riders are much more exposed to the effects of weather and other interference factors, such as poor roadway conditions and unexpected traffic situations. Because of the missing body shell, motorcycle riders are relatively unprotected road users, protective clothing notwithstanding.

In more than 50 percent of the accidents with personal injuries, the rider of a two- or three-wheeled vehicle did not cause the accident, but was simply involved in it. These accidents frequently occur at intersections or junctions, where other road users violate the driving space of the motorcycle rider.

### SUMMARY

Thus, there is a need to increase the safety of two-wheel or three-wheel vehicles.

According to a first example embodiment of the present invention, a method is provided for avoiding an accident or for reducing the effects of an accident for a rider of a vehicle, especially a two- or three-wheeled vehicle. In a first method step, information is ascertained by a first accident-preventing system and/or a first system for mitigating the effects of an accident. In a second method step, the information is transmitted to a second accident-preventing system and/or a second system for mitigating the effects of an accident. In a third method step, the second accident-preventing system and/or the second system for mitigating the effects of an accident are/is preconditioned based on the particular information. The first accident-preventing system and the second accident-preventing system differ from each other. The first system for mitigating the effects of an accident and the second system for mitigating the effects of an accident differ from each other.

A first and a second accident-preventing system may be an ABS (anti-lock braking) system, for example, or a system for monitoring the air pressure in the vehicle tires, a system for adjusting a height of a vehicle's center of gravity, and/or an active steering system. It is furthermore possible that the first accident-preventing system is a system having a predictive sensor system, such as a system equipped with a video camera and/or radar and/or lidar sensors. These systems may possibly prevent a collision with an obstacle or another road user. Systems which mitigate the effects of an accident may be, for example, an airbag system; a belt tightener system of a rider restraint system; a bracing system; the transmission of an emergency call; an activation of a warning device which is disposed on the vehicle and can be noticed by other road users, such as a hazard light or a horn; a measuring system for measuring an abrupt pressure increase in a vehicle tire; and/or a system for adjusting a height of a vehicle's center of gravity. These systems are active when the vehicle has already encountered an impact against an obstacle or against another road user, i.e., when the vehicle has already been involved in a collision. The term ‘preconditioning’ means that the second accident-preventing system is activated and/or the second system for mitigating the effects of an accident are/is actively prepared for a collision. Thus, if the first accident-preventing system is embodied as a system for monitoring the air pressure in a vehicle tire, for example, this system can transmit information to the second accident-preventing system in the event that a drop below a predefined tire air pressure value has occurred. If the second accident-preventing system is embodied as an ABS system, a braking operation may be initiated without participation of the motorcycle rider, in order to protect the rider from a fall caused by a vehicle tire having insufficient air pressure. Furthermore, when a rider initiates a full braking operation on account of a dangerous situation, for example, the control signal from the ABS control unit may be used as information if, for instance, the brake pressure is controlled for more than a predefined period of time, such as one second. This information can be transmitted to a second accident-preventing system and/or a second system for mitigating the effects of an accident. As a result, a belt-tightener system of the rider restraint system, for example, may then be activated, so that a “belt looseness” is reduced to a minimum, without a collision having occurred as yet. A “belt looseness” means that the belt does not restrict the driver's freedom of movement on the vehicle. Based on this information, it is also possible to deploy systems that reduce the effects of an accident, such as bracing systems equipped with support elements that are situated on the side or front and are able to be launched in reversible or irreversible manner, for the purpose of preventing the motorcycle from tipping over or for additional support of the front wheel fork. For example, said information, which could be the ABS control signal, may also be used to activate a system for adjusting the height of the vehicle's center of gravity, so that the vehicle's center of gravity is lowered in the direction of the road. For one, this may shorten the braking distance since the roll-over tendency of the motorcycle is reduced and possibly higher braking forces are therefore transmittable. Reduction of the height of the vehicle's center of gravity may also cause the vehicle not to roll over once the impact has occurred, i.e., after the collision, whereas the vehicle may have rolled over if the center of gravity had remained unchanged. Said information in conjunction with an airbag system that mitigates the accident effects may be used to adapt threshold values which are utilized to trigger the airbag, to the currently existing situation as rapidly as possible. For example, said information may be used in a situation in which the vehicle is vulnerable to rollover, so that the vehicle can be protected against a rollover at least until a collision takes place, using an accident-preventing, active steering system. By appropriate steering angles, the vehicle is able to be stabilized. Especially in conjunction with an accident-preventing system provided with a predictive sensor system, the active steering system, for example, may also be utilized to guide a vehicle that is racing toward congestion distributed across multiple lanes, into a gap which has been detected by the system equipped with the predictive sensor system, without any participation of the driver. Also, for example when another road user rams said vehicle and the air bag system mitigating the accident effects is possibly triggered as a consequence, the accident-preventing ABS system may use this information to lock the brakes of the vehicle without involvement of the driver. Furthermore, the measuring system for measuring an abrupt pressure increase in a vehicle wheel is able to determine a sudden pressure increase, such as in the case of an impact of the vehicle against an obstacle. As a result of this information, for example, the airbag system may be triggered irreversibly, without this action requiring information from the acceleration sensor integrated into the airbag system. In addition, earlier information, such as from the ABS control signal, may be used to precondition the airbag system, for instance by adapting the threshold values, in order to ultimately trigger the system on the basis of the information from the measuring system for measuring an abrupt pressure increase in a vehicle tire. It is also possible to transmit an emergency call after the vehicle has struck an obstacle or to activate warning devices that are disposed on the vehicle and can be seen or heard by other road users.

According to an example embodiment of the present invention, the first accident-preventing system is selected from among a group including an ABS (anti-lock braking) system, an active steering system, a system for monitoring the air pressure in the vehicle tires, a system that includes a predictive sensor system, and a system for adjusting a height of a vehicle's center of gravity. The second accident-preventing system is selected from a group including an ABS (anti-lock braking) system, an active steering system, a system for monitoring the air pressure in the vehicle tires, and a system for adjusting a height of a vehicle's center of gravity.

The first system for mitigating the effects of an accident and the second system for mitigating the effects of an accident are selected from a group including an ABS system, a belt-tightening system of a rider restraint system, a bracing system, a transmission of an emergency call, an activation of a warning device installed in the vehicle and seen or heard by other road users, a measuring system for measuring an abrupt pressure increase in a vehicle tire, a system for avoiding lateral rollover, and a system for adjusting the height of a vehicle's center of gravity.

The system for adjusting the height of a vehicle's center of gravity may be considered both an accident-preventing system and a system that mitigates the effects of an accident. For one, shifting the vehicle's center of gravity in the direction of the road during a braking maneuver makes it possible to generate higher braking pressures until the vehicle wheel locks, so that shorter braking distances are able to be achieved. For another, lowering the vehicle's center of gravity toward the road reduces a rollover risk of the vehicle following a collision.

According to another exemplary development of the present invention, the preconditioning of the second system for mitigating the effects of an accident is reversible.

This makes it possible to shift systems for mitigating the effects of an accident back into their original position if an expected collision does not take place.

According to an example embodiment of the present invention, the first accident-preventing system and/or the first system for mitigating the effects of an accident and the second accident-preventing system and/or the second system for mitigating the effects of an accident are in communicating connection via a bus system.

The information obtained by one system is able to be made available to the other systems. This makes it possible to use the information produced by the individual systems multiple times, without further sensors being required for this purpose. In the same way, sensor information already acquired by one of the systems may be made available to another of the systems or to multiple systems. Such a bus system may be configured as a CAN system, for example.

According to an example embodiment of the present invention, the information is an ABS control signal of an ABS control device.

An ABS control signal indicates a critical driving situation in which no accident has occurred yet, however. Therefore, the ABS control signal may be used for preconditioning the second accident-preventing system and/or the first and/or the second system for mitigating the effects of an accident. That is to say, an accident-preventing system determines the first information for this particular purpose.

According to another example of the present invention, in one method step, an actuator from a group including an ABS system, a belt-tightener system of a rider restraint system, a bracing system, an active steering system, a system for adjusting a height of a vehicle's center of gravity, and a first control device are connected to each other. The actuator is controllable by the first control device. In another method step, the first control device and the second control device are interconnected. In a third method step, the second control device and a sensor are connected to each other. In a further method step, a measured value is acquired by the sensor. In a further method step, the second control device compares the measured value with a threshold value. In an additional method step, information is generated by the second control device when the threshold value has been reached. In a further method step, the second control device transmits the information to the first control device. In another method step, the actuator is controlled by the first control device.

According to another example embodiment of the present invention, in a further method step the information is subjected to a plausibility check using additional information, the additional information being determined from among a group which includes the first accident-preventing system, the second accident-preventing system, the first system for mitigating the effects of an accident, and the second system for mitigating the effects of an accident, and the information and the additional information differ from each other.

The additional information may be obtained directly from a measured value of a sensor, or it may be a variable that is derived from the measured value. As a result, the measured values, which are generated in an acceleration sensor of the ABS system, for example, may be used not only to determine a wheel rotation, but also to determine the current speed of the vehicle. Based on the current speed, it may then be decided whether preconditioning of the second accident-preventing system and/or the second system for mitigating the effects of an accident is necessary to begin with.

According to an example embodiment of the present invention, a vehicle is provided, which is set up to avoid an accident or to mitigate the effects of an accident for a rider of the vehicle, especially a two-wheel or three-wheel vehicle. Information is ascertained by a first accident-preventing system and/or a first system for mitigating the effects of an accident. The information is transmitted to a second accident-preventing system and/or a second system for mitigating the effects of an accident. The second accident-preventing system and/or the second system for mitigating the effects of an accident are/is preconditioned based on the first information. The first accident-preventing system and the second accident-preventing system differ from each other, as do the first system for mitigating the effects of an accident and the second system for mitigating the effects of an accident.

The example embodiments of the present invention are implementable in the form of a method for avoiding an accident or for mitigating the effects of an accident for a rider. The example embodiments of the present invention are implementable in the form of a vehicle set up to avoid an accident or to mitigate the effects of an accident for a rider of the vehicle. The individually described features are able to be combined in various ways in order to obtain other developments of the present invention as well.

Specific embodiments of the present invention are explained in the following text with reference to the appended drawings. The figures are only schematic and not drawn true to scale.

### BRIEF DESCRIPTION OF THE DRAWINGS

FIG. 1 is a flowchart that shows a method for avoiding an accident or for reducing the effects of an accident for a rider of a vehicle, according to an example embodiment of the present invention.

FIG. 2 is a flowchart that shows a subdivision of a third method step of the method of FIG. 1, in which an accident-preventing system and/or a system for reducing the effects of an accident include(s) an actuator, according to an example embodiment of the present invention.

FIG. 3 is a diagram that shows a data flow of the method of FIG. 1, in which a first accident-preventing system, developed as an ABS system, transmits information to a second system for mitigating the effects of an accident, which is developed as a belt tightener system of a rider restraint system, according to an example embodiment of the present invention.

### DETAILED DESCRIPTION

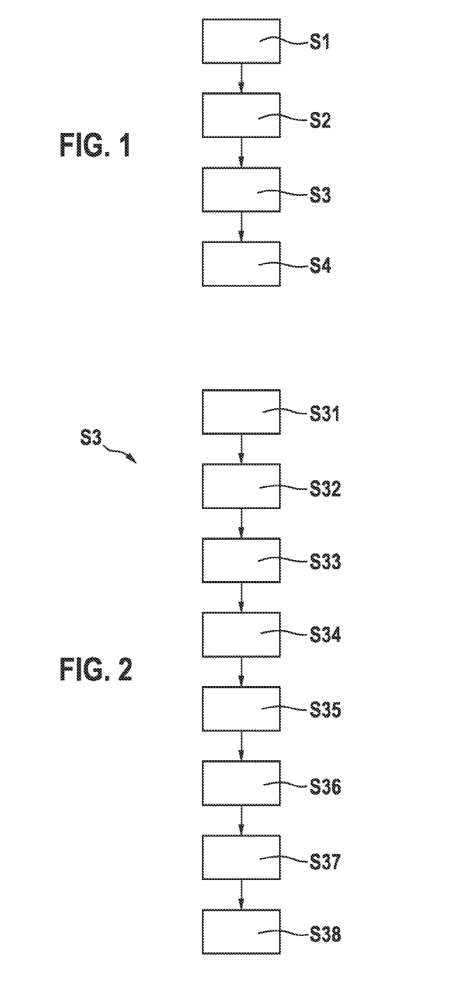

FIG. 1 shows a method for avoiding an accident or for reducing the effects of an accident for a rider of a vehicle, especially a two- or three-wheeled vehicle. In a first method step S1, information is determined by a first accident-preventing system and/or a first system for mitigating the effects of an accident. In a second method step S2, the information is transmitted to a second accident-preventing system and/or a second system for mitigating the effects of an accident. In a third method step S3, the second accident-preventing system and/or the second system for mitigating the effects of an accident are/is preconditioned based on said information. The first and the second accident-preventing system differ from each other, as do the first and the second system for mitigating the effects of an accident. The first and the second accident-preventing systems may be selected from a group including an ABS (anti-lock braking system), an active steering system, a system for monitoring the air pressure in the vehicle tires, and a system for adjusting a height of a vehicle's center of gravity. The group for the first accident-preventing system is furthermore supplemented by a system equipped with a predictive sensor system. The first and the second system for mitigating the effects of an accident are selected from a group that includes an airbag system, a belt-tightening system of an rider restraint system, a bracing system, a transmission of an emergency call, an activation of a warning device installed in the vehicle and able to be seen or heard by other road users, a measuring system for measuring an abrupt pressure increase in a vehicle tire, and a system for adjusting the height of a vehicle's center of gravity. In a fourth method step S4, the information is subjected to a plausibility check using further information, the further information being determined from among a group including the first accident-preventing system, the second accident-preventing system, the first system for mitigating the effects of an accident, and the second system for mitigating the effects of an accident. The information and the further information differ.

FIG. 2 shows a subdivision of method step S3 of FIG. 1, if the accident-preventing system and/or the system for mitigating the effects of an accident are/is equipped with an actuator. The actuator will usually be provided in an ABS system, in a belt tightener system of a rider restraint system, a bracing system, an active steering system, a system for avoiding lateral rollover, and/or a system for adjusting a height of a vehicle's center of gravity. According to a first method step S31, the actuator and a first control device are interconnected, in which case the actuator is controllable by the first control device. In a second method step S32, the first control device and a second control device are interconnected. In a third method step S33, the second control device and a sensor are connected to each other. In a method step S34, a measured value is acquired by the sensor. In a fifth method step S35, the second control device compares the measured value with a threshold value. In a sixth method step S36, information is generated by the second control device when the threshold value has been reached. In a seventh method step S37, the second control device transmits the information to the first control device. In an eighth method step S38, the actuator is controlled by the first control device. The actuator may be actuable in a reversible or irreversible manner.

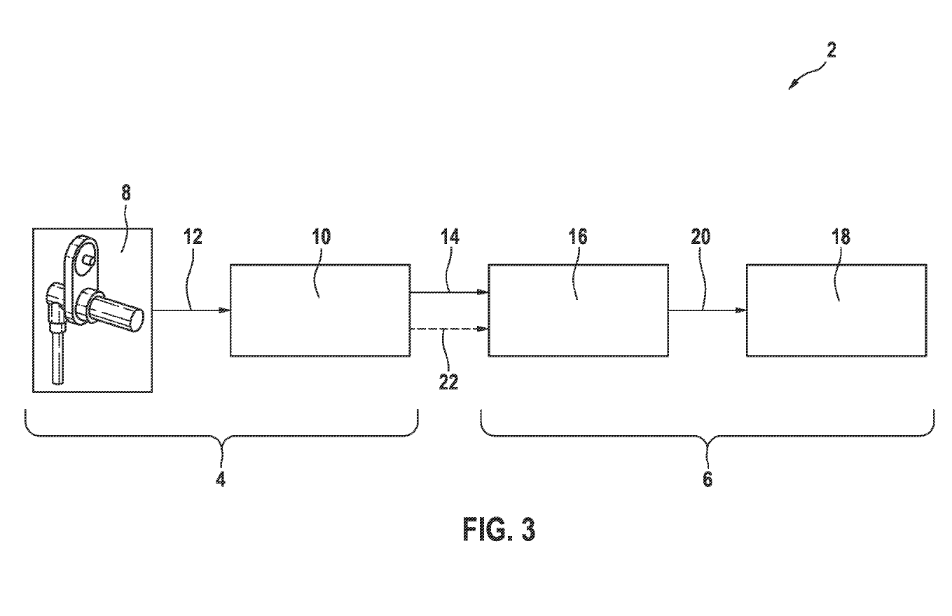

FIG. 3 shows a data flow corresponding to the method of FIG. 1. A first accident-preventing system 4 is developed as an ABS system. A second system 6 for mitigating the effects of an accident is developed as a belt tightener system of a rider restraint device. ABS system 4 has a sensor 8, which is developed as a wheel-speed sensor and is connected to a second control device 10, which is developed as an ABS control device. The measured value acquired by sensor 8 is transmitted to ABS control device 10, the transmission being illustrated by a first arrow 12, and compared to a threshold value which is stored in ABS control device 10. Usually, two sensors 8 are used for detecting the wheel speed, one for detecting the wheel speed of a front vehicle wheel, and the other for detecting the wheel speed of a rear vehicle wheel. If ABS control device 10 in the example embodiment is operated in a closed-loop control for more than approximately one second or some other predefinable value, information is generated by ABS control device 10. This information is transmitted from ABS control device 10 to a first control device 16 of belt tightener system 6, which transmission is illustrated by a second arrow 14. First control device 16 controls an actuator 18 which reduces a belt looseness to a minimum before a collision of the vehicle has taken place. This process is reversible. If no collision occurs, the actuator is returned to its original position and the belt looseness is maximized. By appropriate mathematical formulas or algorithms, for example, a speed of the vehicle (not shown here) is able to be determined in ABS control device 10 on the basis of the measured value from sensor 8. Further information is optionally able to be transmitted from ABS control device 10 to first control device 16, as indicated by a fourth arrow 22 denoted by dashed lines. First control device 16 is therefore able to compare the information transmitted along second arrow 14 with further information transmitted along fourth arrow 22, and to check it for plausibility. The control of actuator 18 may thus be made dependent upon the further information, so that an unnecessary actuation of actuator 18 is avoidable. First accident-preventing system 4 and second system 6 for mitigating the effects of an accident are in communicative connection via a CAN bus system, so that information obtained by first system 4 is able to be made available to the second system.

With the aid of the described method, information from a first accident-preventing system or a system for mitigating the effects of an accident is able to be transmitted to a second accident-preventing system or a system for mitigating the effects of an accident. Actuators may therefore be preconditioned in order to thereby mitigate the effects of an accident in a collision with an obstacle or a road user. Duplicate sensing or duplicate calculations are avoidable due to the fact that the individual systems are able to access each other's information, which therefore makes it possible to reduce the development expense. As a benefit to the rider of the two-wheel vehicle or the three-wheel vehicle, accidents are able to be reduced without intervention by the driver, through cooperation between the first system and the second system, or the effects of an accident due to a collision are able to be reduced.

1-9. (canceled)

10. A method for avoiding an accident or for reducing the effects of an accident for a rider of a vehicle, comprising:
at least one of a first accident-preventing system and accident-effect-mitigation system ascertaining information;
transmitting the information to at least one of a second accident-preventing system and accident-effect-mitigation system;
preconditioning the at least one of the second accident-preventing system and accident-effect-mitigation system based on the transmitted information;
wherein the at least one of the first accident-preventing system and accident-effect-mitigation system differs from the at least one of the second accident-preventing system and accident-effect-mitigation system.

11. The method of claim 10, wherein:
the first accident-preventing system is selected from a group consisting of: an anti-lock braking (ABS) system, an active steering system, a system for monitoring air pressure in the vehicle tires, a system including a predictive sensor system, and a system for adjusting a height of the vehicle's center of gravity;
the second accident-preventing system is selected from a group consisting of: an ABS system, an active steering system, a system for monitoring air pressure in the vehicle tires, and a system for adjusting the height of the vehicle's center of gravity,
each of the first and second accident-effect-mitigation systems is selected from a group consisting of an airbag system, a belt tightener system of a rider restraint system, a bracing system, a system for transmission of an emergency call, an activator of a warning device which is disposed on the vehicle and can be seen or heard by other road users, a measuring system for measuring an abrupt pressure increase in a vehicle tire, a system for avoiding lateral rollover, and a system for adjusting the height of a vehicle's center of gravity.

12. The method of claim 10, wherein the preconditioning is reversible.

13. The method of claim 10, wherein at least one of (a) the at least one of the first accident-preventing system and accident-effect-mitigation system, and (b) the at least one of the second accident-preventing system and accident-effect-mitigation system are communicatively connected via a bus system.

14. The method of claim 10, wherein the information is an anti-lock braking (ABS) control signal of an ABS control device.

15. The method of claim 10, wherein:
an actuator from of one of an anti-lock braking (ABS) system, a belt tightener system of a rider restraint system, a bracing system, an active steering system, and a system for adjusting a height of a vehicle's center of gravity is connected to a first control device;
the actuator is controllable by the first control device;
the first control device and a second control device are interconnected;
the second control device and a sensor are interconnected;
the ascertainment of the information includes:
the sensor detecting a measured value;
the second control device comparing the measured value with a threshold value;
the second control device generating the information responsive to the threshold value being reached;
the transmitting of the information includes the second control device transmitting the information to the first control device; and
the preconditioning includes the first control device controlling the actuator.

16. The method as recited in one of the preceding claims, further comprising:
performing a plausibility check of the information using further information, the further information being ascertained from at least one of the first accident-preventing system, the second accident-preventing system, the first accident-effect-mitigation system, and the second accident-effect-mitigation, the information and the further information being different.

17. The method of claim 10, wherein the vehicle is less than a four-wheeled vehicle.

18. The method of claim 17, wherein the vehicle is a two-wheeled vehicle.

19. The method of claim 17, wherein the vehicle is a three-wheeled vehicle.

20. A vehicle including an arrangement, the arrangement being configured to at least one of avoid and reduce effects of an accident for a rider of the vehicle, and the arrangement comprising:
at least one of a first accident-preventing system and accident-effect-mitigation system configured to ascertain information; and
at least one of a second accident-preventing system and accident-effect-mitigation system arranged for receiving from the at least one of the first accident-preventing system and accident-effect-mitigation system, and being preconditioned based on, the information;
wherein the at least one of the first accident-preventing system and accident-effect-mitigation system differs from the at least one of the second accident-preventing system and accident-effect-mitigation system.

21. The vehicle of claim 20, wherein the vehicle is less than a four-wheeled vehicle.

22. The vehicle of claim 21, wherein the vehicle is a two-wheeled vehicle.

23. The vehicle of claim 21, wherein the vehicle is a three-wheeled vehicle.

24. A system configured to at least one of avoid and reduce effects of an accident for a rider of a vehicle, the system comprising:
at least one of a first accident-preventing system and accident-effect-mitigation system configured to ascertain information; and
at least one of a second accident-preventing system and accident-effect-mitigation system arranged for receiving from the at least one of the first accident-preventing system and accident-effect-mitigation system, and being preconditioned based on, the information;
wherein the at least one of the first accident-preventing system and accident-effect-mitigation system differs from the at least one of the second accident-preventing system and accident-effect-mitigation system.
